(19) United States
(12) Patent Application Publication
(10) Pub. No.: US 2024/0176837 A1
(43) Pub. Date: May 30, 2024

(54) METHOD AND SYSTEM TO SUPPORT ACCESSIBILITY TO WEB PAGE

(71) Applicant: VMware, Inc., Palo Alto, CA (US)

(72) Inventors: LEI NI, Beijing (CN); Sheri BYRNE-HABER, Cupertino, CA (US); Zhenyu LUO, Beijing (CN); Zhen Jim PENG, Palo Alto, CA (US); Zohar HIRSHFELD, Los Gatos, CA (US)

(73) Assignee: VMware, Inc., Palo Alto, CA (US)

(21) Appl. No.: 18/102,773

(22) Filed: Jan. 30, 2023

(30) Foreign Application Priority Data
Nov. 30, 2022 (WO) PCT/CN2022/135501

(51) Int. Cl. G06F 16/957; G06F 40/117; G06F 40/143; G06F 40/166

(52) U.S. Cl. CPC G06F 16/9574; G06F 40/117; G06F 40/143; G06F 40/166

(57) ABSTRACT

Example methods and systems to support accessibility to a web page are disclosed. One example method includes examining a document to be rendered to the web page and determining whether an accessibility issue exists in the document. In response to determining that the accessibility issue exists in the document, the example method further includes determining whether a first remediation of the document corresponding to the accessibility issue exists. In response to determining that the first remediation exists, the example method further includes performing the first remediation to the document to generate a first remediated document to be rendered to the web page. After performing the first remediation, the example method includes examining the first remediated document and determining whether an additional accessibility issue exists in the first remediated document.

### CROSS-REFERENCE TO RELATED APPLICATION

The present application claims the benefit of Patent Cooperation Treaty (PCT) Application No. PCT/CN2022/135501, filed Nov. 30, 2022, which is incorporated herein by reference.

### BACKGROUND

Unless otherwise indicated herein, the approaches described in this section are not admitted to be prior art by inclusion in this section

Some contents on web pages are not friendly for impaired users to access. However, supporting accessibility to web pages requires significant resources. To achieve digital equity, improvements to support accessibility to web pages are needed.

### BRIEF DESCRIPTION OF DRAWINGS

FIG. 1 is a schematic diagram illustrating an example virtualized computing environment that supports accessibilities to one or more web pages, according to one or more embodiments of the present disclosure;

FIG. 2 is a flow diagram of an example process to support accessibilities to one or more web pages, according to one or more embodiments of the present disclosure;

FIG. 3 is a flow diagram of an example process to remediate one or more label issues in a web page, according to one or more embodiments of the present disclosure; and

FIG. 4 is a flow diagram of an example process to remediate one or more contrast issues in a web page, according to one or more embodiments of the present disclosure.

FIG. 5 is a block diagram of an illustrative embodiment of a computer program product for implementing the processes of FIG. 2, FIG. 3, and FIG. 4, according to one or more embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting.

Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used throughout the present disclosure to describe various elements, these elements should not be limited by these terms. These terms are used to distinguish one element from another. In other embodiments, a first element may be referred to as a second element, and vice versa.

In some embodiments, the disclosure provides a method to support accessibility to a web page are disclosed. The method includes examining a document to be rendered to the web page and determining whether an accessibility issue exists in the document. In response to determining that the accessibility issue exists in the document, the method further includes determining whether a first remediation of the document corresponding to the accessibility issue exists. In response to determining that the first remediation exists, the method further includes performing the first remediation to the document to generate a first remediated document to be rendered to the web page. After performing the first remediation, the method further includes examining the first remediated document and determining whether an additional accessibility issue exists in the first remediated document.

In the disclosure, an “input element” may refer to an element in a Hyper Text Markup Language (HTML) document configured to create interactive controls for a web-based form to accept data from a user.

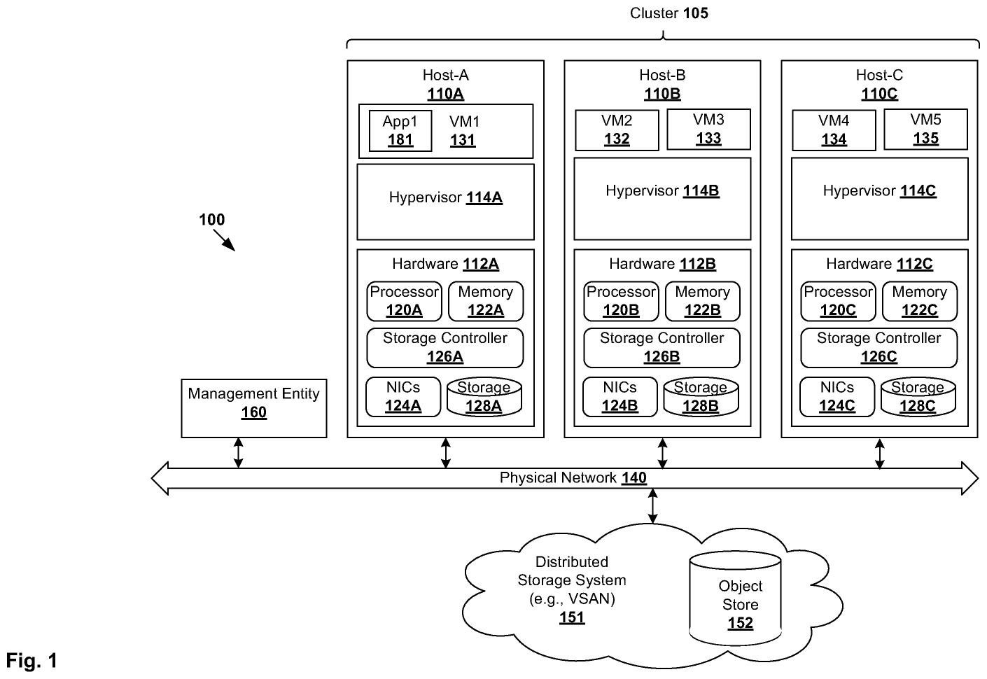

Challenges relating to support accessibilities to one or more web pages in a virtualized computing environment will now be explained in more detail using FIG. 1, which is a schematic diagram illustrating example virtualized computing environment 100. It should be understood that, depending on the desired implementation, virtualized computing environment 100 may include additional and/or alternative components than that shown in FIG. 1.

In the example in FIG. 1, virtualized computing environment 100 includes cluster 105. Cluster 105 may include one or more hosts. For example, cluster 105 includes host-A 110A, host-B 110B and host-C 110C. In the following, reference numerals with a suffix “A” relates to host-A 110A, suffix “B” relates to host-B 110B, and suffix “C” relates to host-C 110C. Although three hosts (also known as “host computers”, “physical servers”, “server systems”, “host computing systems”, etc.) are shown for simplicity, cluster 105 may include any number of hosts. Although one cluster 105 is shown for simplicity, virtualized computing environment 100 may include any number of clusters.

Each host 110A/110B/110C in cluster 105 includes suitable hardware 112A/112B/112C and executes virtualization software such as hypervisor 114A/114B/114C to maintain a mapping between physical resources and virtual resources assigned to various virtual machines. For example, Host-A 110A supports VM1 131; host-B 110B supports VM2 132 and VM3 133; and host-C 110C supports VM4 134 and VM5 135. In practice, each host 110A/110B/110C may support any number of virtual machines, with each virtual machine executing a guest operating system (OS) and applications. Hypervisor 114A/114B/114C may also be a “type 2” or hosted hypervisor that runs on top of a conventional operating system (not shown) on host 110A/110B/110C.

Although examples of the present disclosure refer to “virtual machines,” it should be understood that a “virtual machine” running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system such as Docker, etc.; or implemented as an operating system level virtualization), virtual private servers, client computers, etc. The virtual machines may also be complete computation environments, containing virtual equivalents of the hardware and software components of a physical computing system.

Hardware 112A/112B/112C includes any suitable components, such as processor 120A/120B/120C (e.g., central processing unit (CPU)); memory 122A/122B/122C (e.g., random access memory); network interface controllers (NICs) 124A/124B/124C to provide network connection; storage controller 126A/126B/126C that provides access to storage resources 128A/128B/128C, etc. Corresponding to hardware 112A/112B/112C, virtual resources assigned to each virtual machine may include virtual CPU, virtual memory, virtual machine disk(s), virtual NIC(s), etc.

Storage controller 126A/126B/126C may be any suitable controller, such as redundant array of independent disks (RAID) controller, etc. Storage resource 128A/128B/128C may represent one or more disk groups. In practice, each disk group represents a management construct that combines one or more physical disks, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, Integrated Drive Electronics (IDE) disks, Universal Serial Bus (USB) storage, etc.

Through storage virtualization, hosts 110A/110B/110C in cluster 105 aggregate their storage resources 128A/128B/128C to form distributed storage system 151, which represents a shared pool of storage resources. For example, in FIG. 1, hosts 110A/110B/110 aggregate respective local physical storage resources 128A/128B/128C into object store 152. Data stored in object store 152 may be placed on, and accessed from, one or more of storage resources 128A/128B/128C. In practice, distributed storage system 151 may employ any suitable technology, such as Virtual Storage Area Network (vSAN) from VMware, Inc.

In virtualized computing environment 100, management entity 160 provides management functionalities to various managed objects, such as cluster 105, hosts 110A-110C, virtual machines 131-135, etc. Management entity 160 may include a management application (e.g., VMware vSphere®, VMware vCenter Server®, etc.) having a first user interface (UI) to manage these objects, such as cluster 105, hosts 110A-110C, virtual machines 131-135 in virtualized computing environment 100.

App1 181 running on VM1 131 may verify accessibility issues in a Hyper Text Markup Language (HTML) document configured to be rendered on a web browser. In response to verifying accessibility issues existing in the HTML document, App1 181 may provide remediations to address the verified accessibility issues. Some example accessibility issues include, but not limited to, a label missing for an element of the HTML document or a low contrast level of an element of the HTML document.

Missing labels between elements in a HTML document may cause difficulties for a visually impaired user to interact with these elements in the HTML document. For example, simple HTML codes below do not include labels:
<input type=“text” id=“age”> Are you over 18?
<input type=“text” id=“gender”> Are you man or woman?
   noting that <input type=“text” id=“age”> refers to a first text input element with a first identification code of “age,” which will be rendered on a web browser as a first text input box for a user to enter texts as a first input. Similarly, <input type=“text” id=“gender”> refers to a second text input element with a second identification code of “gender,” which will be rendered on the web browser as a second text input box for the user to enter texts as a second input. For example, the first text input box is configured to receive an input of “Yes” or “No” from the user and the second text input box is configured to receive an input of “Men” or “Women” from the user. The HTML code works fine for a sighted user because he or she can clearly see that “Are you over 18?” is placed right after the first text input box which is associated with the first text input box. Similarly, the sighted user can also clearly see that “Are you Men or Women?” is placed right after the second text input box which is associated with the second text input box.

However, for a visually impaired user relying on a screen reader to interact with elements of this HTML document, the screen reader may read “Enter Input, Are you over 18?” and “Enter Input, Are you Man or Woman?” The second “Enter Input” may cause confusion for the visually impaired user because he or she may not understand this particular “Enter Input” is for the first question “Are you over 18?” or for the second question “Are you Man or Woman?” This confusion may easily escalate when the number of questions in the HTML document increases.

Similarly, a low contrast level associated with an element of the HTML document may be difficult for a visually impaired user to see clearly.

Conventionally, remediations may be performed to address these accessibility issues. However, the remediations are based on simple predefined rules and are usually ineffective because the issues typically remain even after the remediations. Therefore, a more effective approach to support accessibility to web content is needed.

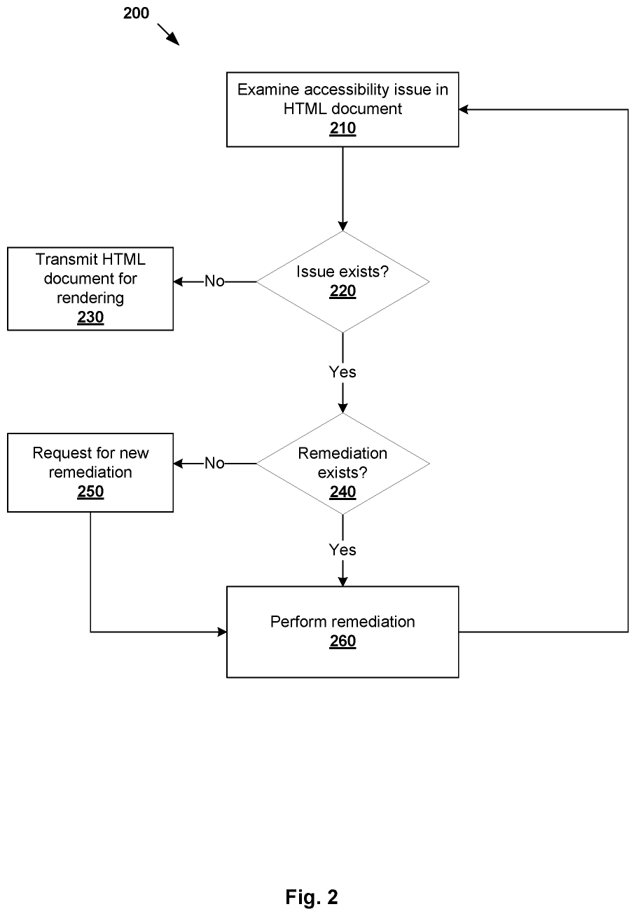

FIG. 2 is a flow diagram of an example process 200 to support accessibilities to one or more web pages, according to one or more embodiments of the present disclosure. Example process 200 may include one or more operations, functions, or actions illustrated by one or more blocks, such as 210 to 260. The various blocks may be combined into fewer blocks, divided into additional blocks, and/or eliminated depending on the desired implementation. In conjunction with FIG. 1, in some embodiments, process 200 may be performed by App1 181 illustrated in FIG. 1.

Process 200 may start with block 210 “examine accessibility issue in HTML document.” In some embodiments, in conjunction with FIG. 1, App1 181 is configured to examine one or more accessibility issues in a HTML document to be rendered to a web browser. Some example accessibility issues may include, but not limited to, a label missing for an input element of the HTML document, a label being not associated with an input element in the HTML document and a low contrast level of an element in the HTML document. Block 210 may be followed by block 220 “issue exists?”

In block 220, in some embodiments, in conjunction with FIG. 1, App1 181 is configured to determine whether an accessibility issue exists in the HTML document based on one or more predefined rules. For example, a first predefined rule may be that “a label is placed before an input element.” A second predefined rule be that “a label is associated with an input element placed after the label.” A third predefined rule may be that “a contrast level of an element in the HTML document is not less than 4.5.” The predefined rule may be stored as one or more object store 152 in distributed storage system 151 for App1 181 accessing. Block 220 may be followed by block 230 “transmit HTML document for rendering.”

In block 230, in some embodiments, in conjunction with FIG. 1, in response to App1 181 determining no accessibility issue exists in the HTML document, App1 181 is configured to transmit the HTML document to a web browser for rendering the HTML document to a web page.

In some embodiments, in response to App1 181 determining one or more accessibility issues exists in the HTML document, block 220 may be followed by block 240 “remediation exists?”

In block 240, in some embodiments, in conjunction with FIG. 1, App1 is configured to determine whether a remediation to the HTML document corresponding to an accessibility issue determined in block 220 exists. For example, a first remediation corresponding to the accessibility issue of a label missing includes creating a label. A second remediation corresponding to the accessibility issue of a label not being associated with an input element after the label includes associating the label to the input element. A third remediation accessibility issue of a low contrast level of an element in the HTML document includes increasing the contrast level of the element, which may further include brightening the foreground of the element and/or darkening the background of the element. In some embodiments, the corresponding remediations may be stored as one or more object store 152 in distributed storage system 151 for App1 181 accessing. Block 240 may be followed by block 250 “request for new remediation.”

In block 250, in some embodiments and in conjunction with FIG. 1, in response to App1 181 determining that no remediation corresponding to the accessibility issue determined in block 220 exists in any object store 152 in distributed storage system 151, App1 181 is configured to request for a new remediation. In some embodiments, the new remediation is generated based on a machine learning technology or a human operator. The new remediation generated in block 250 is then stored as one or more object store 152 in distributed storage system 151 and will become an existing remediation in block 240 in the next loop of process 200.

In response to App1 181 determining that a remediation corresponding to the accessibility issue determined in block 220 exists, block 240 may be followed by block 260 “perform remediation.” In some embodiments, App1 181 is configured to perform one or more remediations to the HTML document based on the first, second and third remediations to address first, second and third accessibility issues set forth above, respectively. App1 181 is configured to generate a remediated document based on the HTML document examined in block 210 and one or more remediations made on such HTML document. Block 260 may be looped back to block 210. Therefore, after performing remediations to the HTML document, App1 181 is configured to further examine the remediated HTML document to determine any accessibility issue still exists in the remediated HTML document before the remediated HTML document can be rendered in block 230.

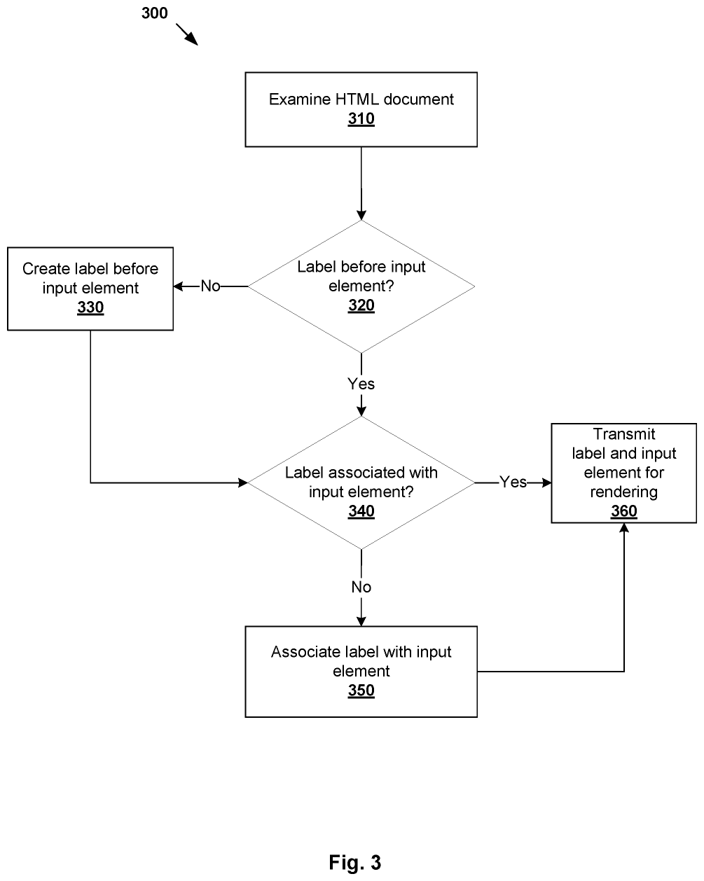

FIG. 3 is a flow diagram of an example process 300 to remediate one or more label issues in a web page, according to one or more embodiments of the present disclosure. Example process 300 may include one or more operations, functions, or actions illustrated by one or more blocks, such as 310 to 360. The various blocks may be combined into fewer blocks, divided into additional blocks, and/or eliminated depending on the desired implementation. In conjunction with FIG. 1, in some embodiments, process 300 may be performed by App1 181 illustrated in FIG. 1.

Process 300 may start with block 310 “examine HTML document.” In some embodiments, in conjunction with FIG. 2, block 310 may correspond to block 210 in FIG. 2. In some embodiments, in conjunction with FIG. 1, App1 181 is configured to examine a HTML document to be rendered to a web browser. For example, App1 181 is configured to obtain information of one or more elements in the HTML document. In some embodiments, the information may be obtained through the “getElement” command of JavaScript. An example HTML document may include:

```
<div align=”middle”>
  <input type=“text” size=“40” id= “age” placeholder=“type something
  here”>
</div>
```

Block 310 may be followed by block 320 “label before input element?”

In some embodiments, in conjunction with FIG. 2, block 320 may correspond to block 220 in FIG. 2. In block 320, in some embodiments, in conjunction with FIG. 1, App1 181 is configured to determine whether a label exists before the input element having the identification code of “age.” Referring back to the above example HTML document, App1 181 determines that there is no label before the input element having the identification code of “age.” In response to determining no label before the input element, block 320 may be followed by block 330 “create label before input element.”

In some embodiments, in conjunction with FIG. 2, block 330 may correspond to block 260 in FIG. 2. In block 330, in some embodiments, in conjunction with FIG. 1, App1 181 is configured to create a label before the input element having the identification code of “age” in the HTML document. Therefore, App1 181 is configured to revise the HTML document to remediate the label missing issue and generate a first remediated HTML document. The first remediated HTML document may be:

```
<div align=”middle”>
  <label>type something here</label>
  <input type=“text” size=“40” id= “age” placeholder=“type something
  here”>
</div>
```

The revised HTML document now includes a label of “<label> type something here</label>” before the input element having the identification code of “age.” Block 330 may be followed by block 340 “label associated with input element?”

After examining the first remediated HTML document in block 330, in conjunction with FIG. 2, block 340 may correspond to block 220 in FIG. 2. In some embodiments, in conjunction with FIG. 1, block 340 is performed after App1 181 examines the first remediated HTML document in block 330. In block 340, in some embodiments, in conjunction with FIG. 1, App1 181 is configured to determine whether a label before the input element is associated with the input element after the label. Referring back to the first remediated HTML document in block 330, the label of “<label> type something here</label>” is a standalone label and not associated with the input element having the identification code of “age.” Block 340 may be followed by block 350 “associate label with input element.”

In some embodiments, in conjunction with FIG. 2, block 350 may correspond to block 260 in FIG. 2. In block 350, App1 181 is configured to revise the first remediated HTML document and generate a second remediated HTML document to remediate the issue of the label not being associated with the input element. The second remediated HTML document may include:

```
<div align=”middle”>
  <label> for= “age” type something here</label>
  <input type=“text” size=“40” id= “age” placeholder=“type something
  here”>
</div>
```

The second remediated HTML document now includes the association of “for=“age”” between the label and the input element having the identification code of “age.” Block 350 may be followed by block 360 “transmit label and input element for rendering.”

In some embodiments, in conjunction with FIG. 2, block 360 may correspond to block 230. In block 360, App1 181 is configured to transmit label and input element to a web browser for rendering the label and the input element on a web page.

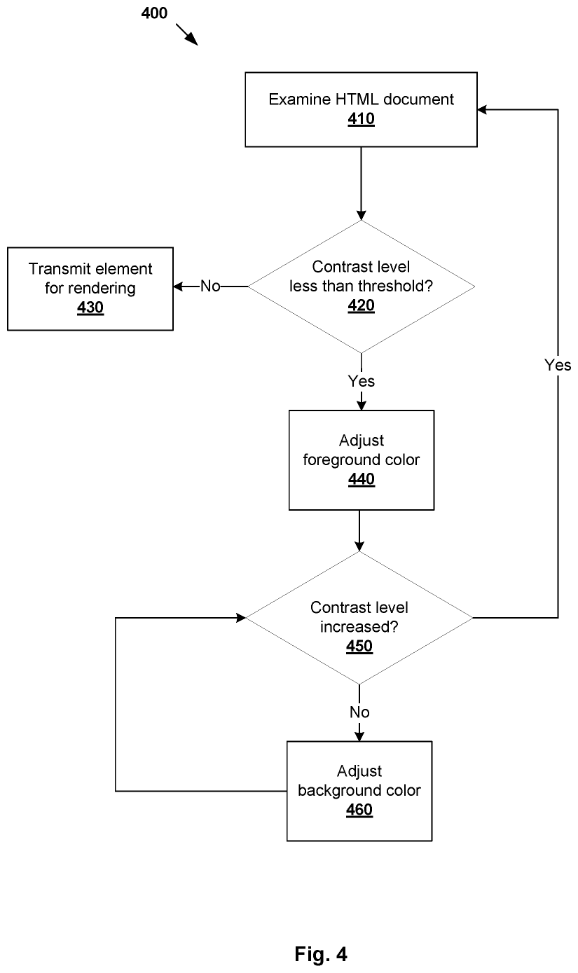

FIG. 4 is a flow diagram of an example process 400 to remediate one or more contrast issues in a web page, according to one or more embodiments of the present disclosure. Example process 400 may include one or more operations, functions, or actions illustrated by one or more blocks, such as 410 to 460. The various blocks may be combined into fewer blocks, divided into additional blocks, and/or eliminated depending on the desired implementation. In conjunction with FIG. 1, in some embodiments, process 400 may be performed by App1 181 illustrated in FIG. 1.

Process 400 may start with block 410 “examine HTML document.” In some embodiments, in conjunction with FIG. 2, block 410 may correspond to block 210 in FIG. 2. In some embodiments, in conjunction with FIG. 1, App1 181 is configured to examine a HTML document to be rendered to a web page. For example, App1 181 is configured to obtain information of one or more elements in the HTML document. In some embodiments, the information includes first set of RGB values of a foreground of an element in the HTML document and second set of RGB values of a background of the element. In some embodiments, in block 410, App1 181 is also configured to calculate a contrast ratio of the element based on the first and second sets of RGB values. Block 410 may be followed by block 420 “contrast level less than threshold?”

In some embodiments, in conjunction with FIG. 2, block 420 may correspond to block 220 in FIG. 2. In block 420, in some embodiments, in conjunction with FIG. 1, App1 181 is configured to determine whether the contrast level calculated in block 410 less than a threshold (e.g., less than 4.5). In response to App1 181 determining the contrast level not less than the threshold, block 420 may be followed by block 430 “transmit element for rendering.” In some embodiments, in conjunction with FIG. 2, block 430 may correspond to block 230.

In some embodiments, in response to App1 181 determining the contrast level less than the threshold, block 420 may be followed by block 440 “adjust foreground color.”

In some embodiments, in conjunction with FIG. 2, block 440 may correspond to block 260 in FIG. 2. In block 440, in some embodiments, in conjunction with FIG. 1, App1 181 is configured to adjust the first set of RGB values of the foreground. More specifically, App1 181 is configured to brighten the foreground by adjusting the first set of RGB values. For example, App1 181 is configured to increase the R value, the G value and/or the B value to brighten the foreground. Block 440 may be followed by block 450 “contrast level increased?”

In some embodiments, in conjunction with FIG. 2, block 450 may correspond to block 220 in FIG. 2. In block 450, App1 181 is configured to calculate an updated contrast level based on the first set of RGB value increased in block 440 and the second set of RGB values of the background and determine whether the updated contrast level is more than the contrast level previously calculated in block 410. In response to determining the updated contrast level is more than the contrast level calculated in block 410, block 450 is looped back to block 410.

In some embodiments, in response to determining the updated contrast level is not more than the contrast level calculated in block 410, block 450 is followed by block 460 “adjust background color.”

In some embodiments, in conjunction with FIG. 2, block 460 may correspond to block 260 in FIG. 2. In block 460, in some embodiments, in conjunction with FIG. 1, App1 181 is configured to adjust the second set of RGB values of the background. More specifically, App1 181 is configured to darken the background by adjusting the second set of RGB values. For example, App1 181 is configured to decrease the R value, the G value and/or the B value to darken the background. Block 460 may be looped back to block 450 to calculate an updated contrast level based on the first set of RGB value increased in block 440 and the second set of RGB values of the background decreased in block 460. In block 450, the updated contrast level is also compared to the previously calculated contrast level to determine whether the updated contrast level is increased. Block 450 is then may looped back to block 410 or followed by block 460 as discussed above. Therefore, based on process 400, only an element having a contrast level not less than the threshold may be rendered on a web page in block 430 so as to address contrast issues in the web page.

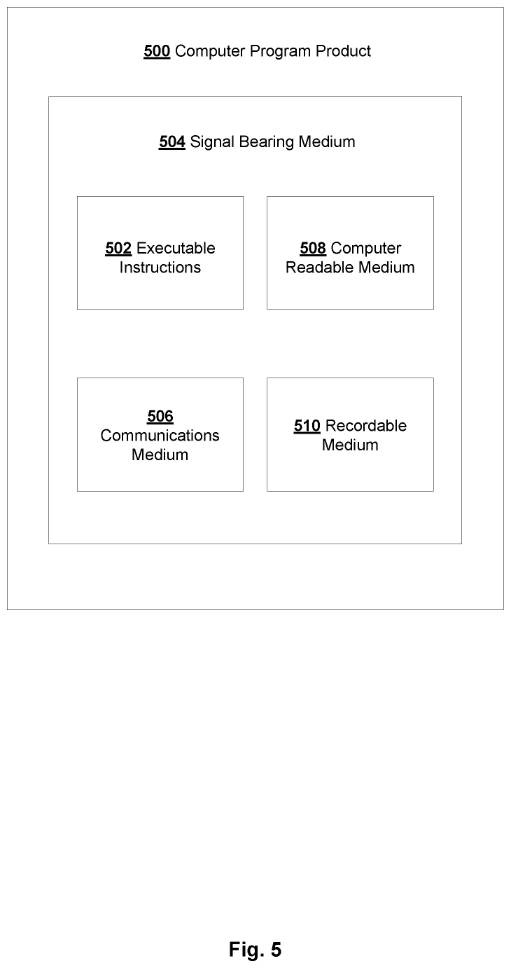

FIG. 5 is a block diagram of an illustrative embodiment of a computer program product 500 for implementing process 200 of FIG. 2, process 300 of FIG. 3 and process 400 of FIG. 4, according to one or more embodiments of the present disclosure.

Computer program product 500 may include a signal bearing medium 504. Signal bearing medium 504 may include one or more sets of executable instructions 502 that, in response to execution by, for example, processor 120A of host-A 110A of FIG. 1, may provide at least the functionality described above with respect to FIGS. 2-4.

In some implementations, signal bearing medium 504 may encompass a non-transitory computer readable medium 508, such as, but not limited to, a solid-state drive, a hard disk drive, a Compact Disc (CD), a Digital Video Disk (DVD), a digital tape, memory, etc. In some implementations, signal bearing medium 504 may encompass a recordable medium 510, such as, but not limited to, memory, read/write (R/W) CDs, R/W DVDs, etc. In some implementations, signal bearing medium 504 may encompass a communications medium 506, such as, but not limited to, a digital and/or an analog communication medium (e.g., a fiber optic cable, a waveguide, a wired communications link, a wireless communication link, etc.). Computer program product 500 may be recorded on non-transitory computer readable medium 508 or another similar recordable medium 510.

A “computer readable medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.).

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 3. For example, a computer system capable of acting as host 110 may be deployed in virtualized computing environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples.

Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedures shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

1. A method to support accessibility to a web page, comprising:
examining a document to be rendered to the web page;
determining whether an accessibility issue exists in the document;
in response to determining that the accessibility issue exists in the document, determining whether a first remediation of the document corresponding to the accessibility issue exists in a distributed storage system;
in response to determining that the first remediation exists, performing the first remediation to the document to generate a first remediated document to be rendered to the web page; and
after performing the first remediation:
examining the first remediated document; and
determining whether an additional accessibility issue exists in the first remediated document.

2. The method of claim 1, further comprising:
in response to determining the accessibility issue does not exist in the document, transmitting the document to a web browser and rendering the document to the web page.

3. The method of claim 1, further comprising:
in response to determining that the first remediation does not exist, requesting for a second remediation corresponding to the accessibility issue.

4. The method of claim 3, wherein the second remediation is generated based on a machine learning technology or a human operator.

5. The method of claim 3, further comprising:
performing the second remediation to the document to generate a second remediated document to be rendered to the web page.

6. The method of claim 5, further comprising:
after performing the second remediation, examining the second remediated document and determining whether an additional accessibility issue in the second remediated document.

7. A non-transitory computer-readable storage medium that includes a set of instructions which, in response to execution by a processor of a computer system, cause the processor to perform a method to support accessibility to a web page, the method comprising:
examining a document to be rendered to the web page;
determining whether an accessibility issue exists in the document, wherein the accessibility issue is associated with an input element of the document;
in response to determining that the accessibility issue exists in the document, performing a first remediation to the document to generate a first remediated document to be rendered to the web page; and
after performing the first remediation:
examining the first remediated document; and
determining whether an additional accessibility issue exists in the first remediated document.

8. The non-transitory computer-readable storage medium of claim 7, wherein the determining whether the accessibility issue exists includes determining that a label is not placed before the input element.

9. The non-transitory computer-readable storage medium of claim 8, wherein performing the first remediation includes creating the label and placing the label before the input element; and wherein the first remediated document includes the input element and the label before the input element.

10. The non-transitory computer-readable storage medium of claim 9, wherein determining whether an additional accessibility issue exists in the first remediated document includes determining whether the label is associated with the input element.

11. The non-transitory computer-readable storage medium of claim 10, including additional instructions which, in response to execution by the processor of the computer system, cause the processor to perform the method further comprising:
in response to determining the label is associated with the input element, transmitting the first remediated document to a web browser to render the first remediated document to the web page.

12. The non-transitory computer-readable storage medium of claim 10, including additional instructions which, in response to execution by the processor of the computer system, cause the processor to perform the method further comprising:
in response to determining the label is not associated with the input element:
associating the label with the input element to generate a second remediated document including the label, the input element and the association between the label and the input element; and
transmitting the second remediated document to a web browser to render the second remediated document to the web page.

13. The non-transitory computer-readable storage medium of claim 9, wherein the determining whether the accessibility issue exists includes determining that a label is placed before the input element; and
in response to determining that the label is placed before the input element, determining whether the label is associated with the input element.

14. A computer system configured to support accessibility to a web page, comprising:
a processor; and
a non-transitory computer-readable medium having stored thereon instructions that, when executed by the processor, cause the processor to:
examine a document to be rendered to the web page;
determine whether an accessibility issue exists in the document, wherein the accessibility issue is associated with a contrast level of an input element of the document;
in response to determining that the accessibility issue exists in the document, perform a first remediation to the document to generate a first remediated document to be rendered to the web page; and
after performing the first remediation:
examine the first remediated document; and
determine whether an additional accessibility issue exists in the first remediated document.

15. The computer system of claim 14, wherein determining the accessibility issue exists includes determining that the contrast level is less than a threshold.

16. The computer system of claim 15, wherein performing the first remediation includes brightening a foreground of the input element.

17. The computer system of claim 16, wherein the non-transitory computer-readable medium has stored thereon additional instructions that, when executed by the processor, cause the processor to determine whether the contrast level is increased after brightening the foreground.

18. The computer system of claim 17, wherein the non-transitory computer-readable medium has stored thereon additional instructions that, when executed by the processor, cause the processor to, in response to determining that the contrast level is not increased, darken a background of the input element.

19. The computer system of claim 17, wherein the non-transitory computer-readable medium has stored thereon additional instructions that, when executed by the processor, cause the processor to, in response to determining that the contrast level is increased, determine whether the increased contrast level is less than the threshold.
